(19) United States
(12) Patent Application Publication
(10) Pub. No.: US 2024/0114417 A1
(43) Pub. Date: Apr. 4, 2024

(54) USER EQUIPMENT HANDOVER

(71) Applicant: QUALCOMM Incorporated, San Diego, CA (US)

(72) Inventors: Naeem Akl, Bridgewater, NJ (US); Ozcan Ozturk, San Diego, CA (US); Navid Abedini, Basking Ridge, NJ (US); Karl Georg Hampel, Jersey City, NJ (US); Tao Luo, San Diego, CA (US)

(21) Appl. No.: 18/145,570

(22) Filed: Dec. 22, 2022

Related U.S. Application Data
(60) Provisional application No. 63/377,650, filed on Sep. 29, 2022.

(51) Int. Cl. H04W 36/24; H04W 36/00; H04W 36/38

(52) U.S. Cl. CPC H04W 36/24; H04W 36/00837; H04W 36/38

(57) ABSTRACT

A method of handover at a user equipment (UE) is provided comprising receiving, from a first network entity (NE), a configuration for conditional handover associated with a second NE. The configuration includes at least one condition. An indication is received by the UE from the first NE to execute the conditional handover. Handover is initiated from the first NE to the second NE subject to the condition being satisfied. The condition may be that the indication is received or it may be a channel condition or both. At an NE, configurations for conditional handover are sent to multiple UEs, each configuration associated with a target NE and each including at least one condition, and an indication is sent to at least one UE to execute conditional handover.

### CROSS-REFERENCE TO RELATED APPLICATION

The present application claims the benefit of U.S. Provisional Patent No. 63/377,650, filed on Sep. 29, 2022, and titled “USER EQUIPMENT HANDOVER,” the disclosure of which is expressly incorporated by reference in its entirety.

### FIELD OF DISCLOSURE

The following relates to the field of wireless communications. Particularly, example aspects of this disclosure relate to wireless communications such as, but not exclusively, between user equipments (UEs) and network entities (NEs), such as mobile nodes of an integrated access and backhaul (IAB) system, where “access” refers to a UE accessing a network and “backhaul” refers to intra-node communications within the network.

### BACKGROUND

Access spectrum has historically been too valuable and limited to use for backhauling. However, with wide millimeter wave (mmWave) bandwidths now becoming available, there is considerable interest in an integrated access and backhaul (IAB) arrangement for 5G New radio (NR) and beyond. IAB can provide flexible and scalable multi-hop backhauling, using the same or different frequency bands for access and backhaul.

The backhaul is forwarded across wirelessly interconnected radio nodes, with the backhaul links terminated by an IAB mobile termination (IAB-MT) function. The IAB-MT could either use a separate antenna or share the access antenna of the base station (virtual IAB-MT).

IAB reuses existing 5G NR functions and interfaces. In the 5G network, a gNodeB (gNB) base station provides NR protocol terminations to the user equipment (UE) and is connected to the 5G Core (5GC) network. The gNB is a logical node, which may be split into one central unit (CU) and one or more distributed units (DU). The CU hosts the higher layer protocols to the UE and terminates the control plane and user plane interfaces to the 5GC. An F1 interface provides end-to-end connection between the CU and the DU (via any intermediate donor DU). The CU controls the DU nodes over the F1 interface. The DU node hosts the lower layers for the NR Uu interface to the UE.

IAB-nodes and donor DU(s) that use the same CU are part of one gNB, in accordance with a CU/DU split architecture. Hence, the wireless backhaul is isolated inside the gNB, and any internal topology, routing or backhaul changes can be made without impacting the 5GC or neighboring gNBs. A similar situation is valid for the UEs, for which the IAB node appears as a normal base station, supporting both NR standalone and non-standalone mode.

A NR backhaul link is between a “parent” on the network side and a “child” at the other end. The DU at the parent schedules the backhaul downstream and upstream traffic to/from the IAB-MT at the child, supporting a subset of the NR UE functionality. This includes lower protocol layer functionality to the parent as well as Radio Resource Control and non-access stratum functionality to the IAB donor CU and 5GC. A “parent” may be an IAB-donor or another parent IAB-node.

The IAB feature is intended to support out-of-band and in-band backhauling, where the latter means usage of the same carrier frequencies for both the NR backhaul links and the access links. In-band operation typically comes with a half-duplex constraint, implying that the IAB-MT part of an IAB node cannot receive while its collocated DU is transmitting and vice versa to avoid intra-site interference.

IAB is expected to be of most benefit in mmWave spectrum, where operators typically have large bandwidth. A time-division-duplex (TDD) network is typically configured with a pattern for the time domain allocation of downlink (DL) and uplink (UL) resources, and an additional level of pattern used to support combined access and backhaul traffic. A typical example might be multiple different repeated IAB time phases for node-local TDD states, where several phases are allocated to the DL and fewer or only one phase allocated to the UL.

### SUMMARY

A number of problems may arise during a handover from a first network entity, NE, to a second NE, for example in accordance with a configuration for conditional handover associated with a second NE. Such problems may include collisions, for example where more than one UE is attempting to handover at the same time, and latency issues. Latency problems may occur between a first NE being switched off and a UE realizing that the link has been lost. This occurs in particular where NEs are logical IAB-DUs, because they may be created when needed and disbanded (turned off) when no longer required. A further problem may be that, if the first NE is not switched off, handover conditions may never be fulfilled. These and other problems may disable migration of UEs across an IAB network.

A method of handover at a user equipment (UE), is provided comprising: receiving, from a first network entity (NE), a configuration for conditional handover associated with a second NE, the configuration including at least one condition; receiving an indication from the first NE to execute the conditional handover; and initiating handover from the first NE to the second NE subject to the condition being satisfied.

The condition may be that the indication is received. I.e., once the indication is received, the condition set out in the configuration is fulfilled. The configuration may be otherwise unconditional, i.e., not conditional on any status or measurement measured at the UE.

Alternatively, the condition may be a channel condition, in which case the method further comprises monitoring a channel, determining when the condition is satisfied and initiating handover from the first NE to the second NE when the indication is received and the condition is satisfied. The condition may be a combination of these two. For example, the configuration may include a first execution condition and a second execution condition, wherein the UE executes the conditional handover based on fulfillment of the first execution conditional on reception of the indication, and executes the conditional handover based on fulfillment of the second execution condition otherwise.

The configuration may include a first execution condition and a second execution condition, the UE may initiate handover to the second NE based on fulfillment of the first execution condition on reception of the indication, but initiate handover to the second NE based on fulfillment of the second execution condition independent of receipt of the indication. Alternatively, the first and second execution conditions may be provided in first and second configurations provided by the first and second NEs respectively.

The UE may report to the first NE a capability to support conditional handover triggered by an indication. This allows the NE to distinguish the UE from a legacy UE that may not have an ability to execute a conditional handover (CHO) configuration on condition that an indication or instruction to execute is received.

In accordance with an aspect of the disclosure, apparatus for wireless communication at a UE is provided, comprising: a memory; and one or more processors operatively coupled to the memory and the one or more processors configured to: receive, from a first NE, a configuration for conditional handover associated with a second NE, the configuration including at least one condition; receive an indication from the first NE to execute the conditional handover; and initiate handover from the first NE to the second NE subject to the condition being satisfied.

In accordance with an aspect of the disclosure, an apparatus for wireless communication at a first NE is provided, comprising: a memory; and one or more processors operatively coupled to the memory and the one or more processors configured to: send configurations for conditional handover to multiple UEs, each configuration associated with a target NE and each including at least one condition; and send an indication to at least one UE to execute conditional handover based on a configuration sent to that UE.

Upon sending the indication to the at least one UE, the first NE can discontinue communications with the UE. For example, it can power down its radio frequency (RF) interface without waiting for any acknowledgement of successful handover.

### BRIEF DESCRIPTION OF THE DRAWINGS

FIG. 1 is a diagram illustrating an example of an integrated access and backhaul (IAB) system, in accordance with various aspects of the present disclosure.

FIG. 2 is a diagram illustrating an example of the various units of FIG. 1 in greater detail, in accordance with various aspects of the present disclosure.

FIG. 3 illustrates the IAB arrangement of FIG. 1 undergoing stages in inter-donor migration, in accordance with various aspects of the present disclosure.

FIGS. 4a, 4b, 4c and 4d are sequence diagrams illustrating an example intra-Access and Mobility Management Function/User Plane Function (intra-AMF/UPF) migration, in accordance with various aspects of the present disclosure.

FIG. 5 is a message flow diagram illustrating an example of conditional handover, in accordance with various aspects of the present disclosure.

FIG. 6 is a message flow diagram illustrating another example of conditional handover, in accordance with various aspects of the present disclosure.

FIG. 7 is a flow diagram showing an example of operation at a user equipment (UE), in accordance with various aspects of the present disclosure.

FIG. 8 is a flow diagram showing an example of operation at a network entity (NE), in accordance with various aspects of the present disclosure.

### DETAILED DESCRIPTION

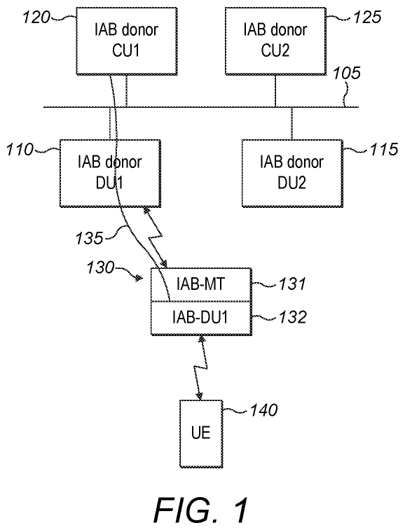

FIG. 1 illustrates an integrated access and backhaul (IAB) system. An IP network 105 is shown that includes an IAB-donor-DU1 110, an IAB-donor-DU2 115, an IAB-donor-CU1 120, and an IAB-donor-CU2 125. The IAB-donor-CU1 120, and IAB-donor-CU2 125 are able to serve a mobile IAB node 130 that comprises an IAB-MT 131 and an IAB-DU1 132 (as well as an IAB-DU2 that is discussed below). The IAB node 130 serves a UE 140. There may be many such UEs 140.

Examples of UEs 140 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 140 may be referred to as IoT devices (e.g., parking meter, gas pump, toaster, vehicles, heart monitor, etc.). The UE 140 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

The IP network 105 may include multiple IAB-donor-DUs and IAB-donor-CUs. The connection from the IAB-DU1 132 to the CU1 via the IAB-donor-CU1 120 forms a first F1 interface 135.

In case of handover that involves no IAB-donor-CU change, no second F1 connection is established. In such case, there is no new F1 interface and no second logical IAB-DU on the IAB-node 130. In such case, the IAB-node 130 will have one IAB-DU (e.g., IAB-DU1 132) before and after a migration.

Infrastructure and spectral resources for radio access may support wireless backhaul link capabilities to supplement wired backhaul connections. In some cases, in the IAB system, one or more network entities (e.g., IAB nodes, etc.) may be partially controlled by each other. One or more IAB nodes may be referred to as a donor entity or an IAB-donor. One or more DUs may be partially controlled by one or more CUs associated with a donor network entity. The one or more donor network entities (e.g., IAB-donor) may be in communication with one or more IAB nodes via supported access and backhaul links. IAB nodes may include IAB-MT (e.g., IAB-MT 131) controlled by IAB-DUs of a coupled IAB-donor. The IAB-MT may include an independent set of antennas for relay of communications with UEs 140, or may share the same antennas of IAB node used for access via IAB-DU (e.g., IAB-DU1 132). In some examples, IAB nodes may include DUs that support communication links with additional entities within the relay chain or configuration of the access network (e.g., downstream).

For instance, an access network (AN) or RAN may include communications between access nodes (e.g., an IAB-donor), IAB nodes, and one or more UEs 140. The IAB-donor may facilitate connection between core network (e.g., 5GC) and the AN. That is, an IAB-donor may refer to a RAN node with a wired or wireless connection to core network. The IAB-donor may include CU (e.g., IAB-donor-CU1 120) and at least one DU (e.g., IAB-donor-DU1 110), in which case CU may communicate with core network over an interface (e.g., a backhaul link). IAB-donor and IAB nodes (e.g., IAB node 130) may communicate over an F1 interface (e.g., first F1 interface 135) according to a protocol that defines signaling messages. Additionally, or alternatively, CU may communicate with the core network over an interface, which may be an example of a portion of backhaul link, and may communicate with other CUs (e.g., CU associated with an alternative IAB donor) over an Xn-C interface, which may be an example of a portion of a backhaul link.

IAB node may refer to a RAN node that provides IAB functionality (e.g., access for UEs 140, wireless self-backhauling capabilities). DU may act as a distributed scheduling node towards child nodes associated with IAB node, and the IAB-MT may act as a scheduled node towards parent nodes associated with IAB node. That is, an IAB donor may be referred to as a parent node in communication with one or more child nodes (e.g., an IAB-donor may relay transmissions for UEs through one or more other IAB nodes). Additionally, or alternatively, IAB node may also be referred to as a parent node or a child node to other IAB nodes, depending on the relay chain or configuration of the AN. Therefore, the IAB-MT entity of IAB nodes may provide a Uu-interface for a child IAB node to receive signaling from parent IAB node, and the DU interface may provide a Uu-interface for parent IAB node to signal to child IAB node or UE 140.

For example, IAB node may be referred to as a parent node that supports communications for a child IAB node, and referred to as a child IAB node associated with an IAB-donor. The IAB-donor may include CU (IAB-donor-CU) with a wired or wireless connection to core network and may act as parent node to IAB nodes. For example, IAB-donor-DU may relay transmissions to UEs 140 through IAB nodes, and may directly signal transmissions to UE 140. IAB-donor-CU may signal communication link establishment via an F1 interface to IAB nodes, and IAB nodes may schedule transmissions (e.g., transmissions to UEs 140 relayed from the IAB donor) through DUs. That is, data may be relayed to and from IAB nodes via signaling over an NR Uu-interface to IAB-MT. Communications with IAB node may be scheduled by IAB-donor-DU and communications with IAB node may be scheduled by IAB-DU.

In some examples, the 5G network may be implemented in a disaggregated architecture (e.g., a disaggregated base station architecture, a disaggregated RAN architecture), which may be configured to utilize a protocol stack that is physically or logically distributed among two or more network entities, such as the IAB system, an open RAN (O-RAN) (e.g., a network configuration sponsored by the O-RAN Alliance), or a virtualized RAN (vRAN) (e.g., a cloud RAN (C-RAN)). For example, network entity may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof. RU may also be referred to as a radio head, a smart radio head, a remote radio head (RRH), a remote radio unit (RRU), or a transmission reception point (TRP). One or more components of network entities in a disaggregated RAN architecture may be co-located, or one or more components of the network entities may be located in distributed locations (e.g., separate physical locations). In some examples, one or more network entities of a disaggregated RAN architecture may be implemented as virtual units (e.g., a virtual CU (VCU), a virtual DU (VDU), a virtual RU (VRU)).

The split of functionality between CU, DU, and RU is flexible and may support different functionalities depending upon which functions (e.g., network layer functions, protocol layer functions, baseband functions, RF functions, and any combinations thereof) are performed at CU, DU, or RU. For example, a functional split of a protocol stack may be employed between CU and DU such that CU may support one or more layers of the protocol stack and DU may support one or more different layers of the protocol stack. In some examples, CU may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). CU may be connected to one or more DUs or RUs, and one or more DUs or RUs may host lower protocol layers, such as layer 1 (L1) (e.g., physical (PHY) layer) or L2 (e.g., radio link control (RLC) layer, medium access control (MAC) layer) functionality and signaling, and may each be at least partially controlled by CU.

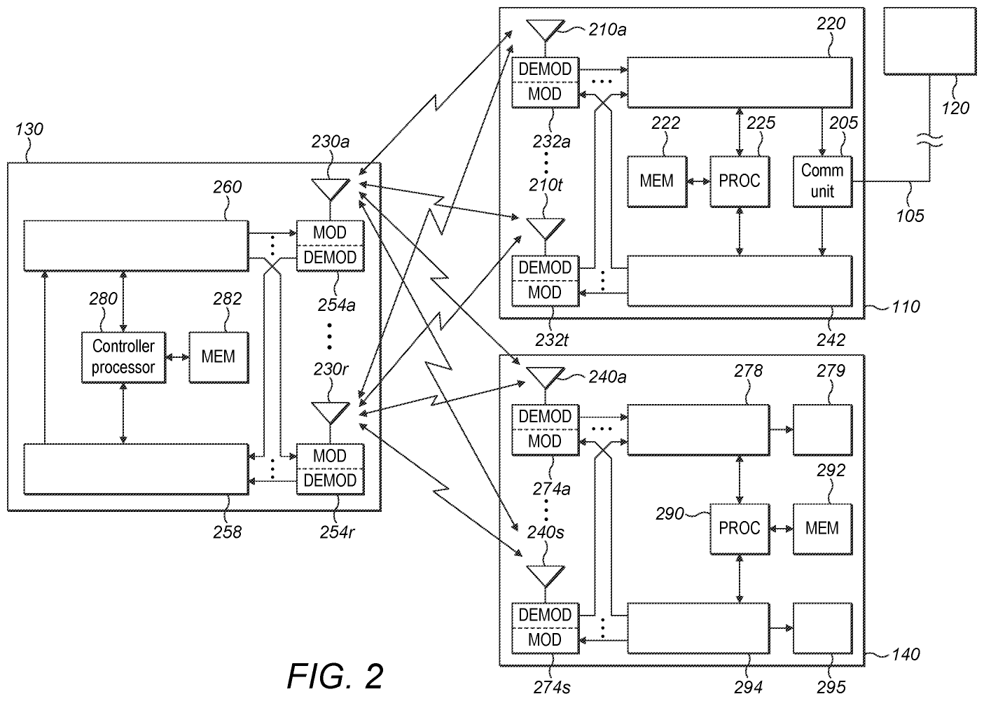

FIG. 2 is a block diagram illustrating an example implementation of the IAB-donor-DU1 110, the IAB-donor-CU1 120, the mobile IAB node 130 and the UE 140 in greater detail, according to various aspects of the present disclosure.

IAB-donor-DU1 110 comprises T antennas 210a through 210t, IAB node 130 may be equipped with R antennas 230a through 230r, and UE 140 may be equipped with S antennas 240a through 240s, where in general T>1, R>1 and S>1.

The IAB-donor-CU1 120 communicates with the IAB-donor-DU1 110 over the internet protocol (IP) network 105, which is shown as wired (or optical) but may be wireless. The IAB-donor-DU1 110 has a communications unit 205 for this purpose. Protocols other than IP can be chosen for this link.

The IAB-donor-DU1 110 communicates with the mobile IAB node 130 via antennas 210a-210t and 230a-230r. The mobile IAB node 130 communicates with the UE 140 via antennas 230a-230r and antennas 240a-240s. Thus, the IAB-donor-DU1 110 communicates with the UE 140 via the mobile IAB node 130.

IAB-donor-DU1 110 comprises a transmit processor 242 that may receive data for one or more UEs (e.g., UE 140) from the communications unit 205. The transmit processor 242 may select one or more modulation and coding schemes (MCS) based at least in part on channel quality indicators (CQIs) received from the mobile IAB node 130, process (e.g., encode and modulate) the data for the IAB node 130 based at least in part on channel and other information from the mobile IAB node 130, and provide data symbols for the transmit antennas 201a-210t. Transmit processor 242 may also process system information (e.g., for semi-static resource partitioning information (SRPI) and/or the like) and control information (e.g., CQI requests, grants, upper layer signaling, and/or the like) and provide overhead symbols and control symbols. Transmit processor 242 may include a transmit (TX) multiple-input multiple-output (MIMO) processor function to perform spatial processing (e.g., precoding) on data symbols, control symbols, overhead symbols, and/or the reference symbols, if applicable, and may provide T output symbol streams to T modulators/demodulators (MODs/DEMODs) 232a through 232t. Each modulator/demodulator 232 may process a respective output symbol stream (e.g., for Orthogonal Frequency Division Multiplexing (OFDM), and/or the like) to obtain an output sample stream. Each modulator/demodulator 232 may further process (e.g., convert to analog, amplify, filter, and upconvert) the output sample stream to obtain a downlink signal. T downlink signals from modulators/demodulators 232a through 232t may be transmitted via the T antennas 210a through 210t, respectively.

At mobile IAB node 130, antennas 230a through 230r may receive the downlink signals from IAB-donor-DU1 110 and/or other IAB-DUs or other nodes and may provide received signals to modulators/demodulators 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A receive processor 258 may obtain received symbols from the R modulators/demodulators 254a through 254r, perform MIMO detection on the received symbols if applicable, provide detected symbols, process (e.g., demodulate and decode) the detected symbols, provide decoded data for passing to a transmit processor 260, and provide decoded control information and system information to a controller/processor 280 having associated memory 282. The term “controller/processor” may refer to one or more controllers, one or more processors, or a combination thereof. The receive processor 258 may determine reference signal received power (RSRP), received signal strength indicator (RSSI), reference signal received quality (RSRQ), channel quality indicator (CQI), and/or the like.

At UE 140, antennas 240a through 240s may receive the downlink signals from the mobile IAB node 130 and/or other base stations and may provide received signals to modulators/demodulators 274a through 274s, respectively. Each demodulator 274 may condition (e.g., filter, amplify, downconvert, and digitize) a received signal to obtain input samples and may further process the input samples (e.g., for OFDM and/or the like) to obtain received symbols. A UE receive processor 278 may obtain received symbols from the S modulators/demodulators 274a through 274s, perform MIMO detection on the received symbols if applicable, provide detected symbols, process (e.g., demodulate and decode) the detected symbols, provide decoded data for the UE 140 to a data sink 279, and provide decoded control information and system information to a controller/processor 290. The receive processor 278 (or the controller/processor 290) may determine reference signal received power (RSRP), received signal strength indicator (RSSI), reference signal received quality (RSRQ), channel quality indicator (CQI), and/or the like. In some aspects, one or more components of UE 140 may be included in a housing (not shown).

On the uplink, at UE 140, a transmit processor 294 may receive and process data from a data source 295 and control information (e.g., for reports that include RSRP, RSSI, RSRQ, CQI, and/or the like) from controller/processor 290. Transmit processor 294 may also generate reference symbols for one or more reference signals. The symbols from transmit processor 294 may be precoded by transmit processor 294 (if applicable) and further processed by modulators/demodulators 274a through 274s, e.g., for Discrete Fourier Transform-spread OFDM (DFT-s-OFDM), Cyclic Prefix-OFDM (CP-OFDM), and/or the like, and transmitted to mobile IAB node 130.

In some aspects, the UE 140 includes a transceiver. The transceiver may include any combination of antenna(s) 240, modulators and/or demodulators 274, receive processor 278 and transmit processor 294. The transceiver may be used by a processor (e.g., controller/processor 290) and memory 292 to perform aspects of any of the methods described herein.

At mobile IAB node 130, the uplink signals from UE 140 and other UEs may be received by antennas 230a through 230r, processed by modulators/demodulators 254a through 254r, detected and further processed by receive processor 258 to obtain decoded data and control information sent by UE 140. Receive processor 258 may provide the decoded data to transmit processor 260 (via a buffer not shown) and provide the decoded control information to controller/processor 280. Transmit processor 260 may receive and process the data from receive processor 258 (via the buffer) and control information (e.g., for reports that include RSRP, RSSI, RSRQ, CQI, and/or the like) from controller/processor 280. Transmit processor 260 may also generate reference symbols for one or more reference signals. The symbols from transmit processor 260 may be precoded by transmit processor 260 (if applicable) and further processed by modulators/demodulators 254a through 254s (e.g., for DFT-s-OFDM, CP-OFDM, and/or the like), and transmitted to IAB-donor-DU1 110.

At IAB-donor-DU1 110, the uplink signals from mobile IAB node 130 and other IAB nodes may be received by antennas 210a through 210t, processed by modulators/demodulators 232a through 232t, detected and further processed by receive processor 220 to obtain decoded data and control information sent by mobile IAB node 130. Receive processor 220 may provide the decoded data to communications unit 205 for onward communication to a user plane function (UPF) described below. The decoded control information is provided to a controller/processor 225.

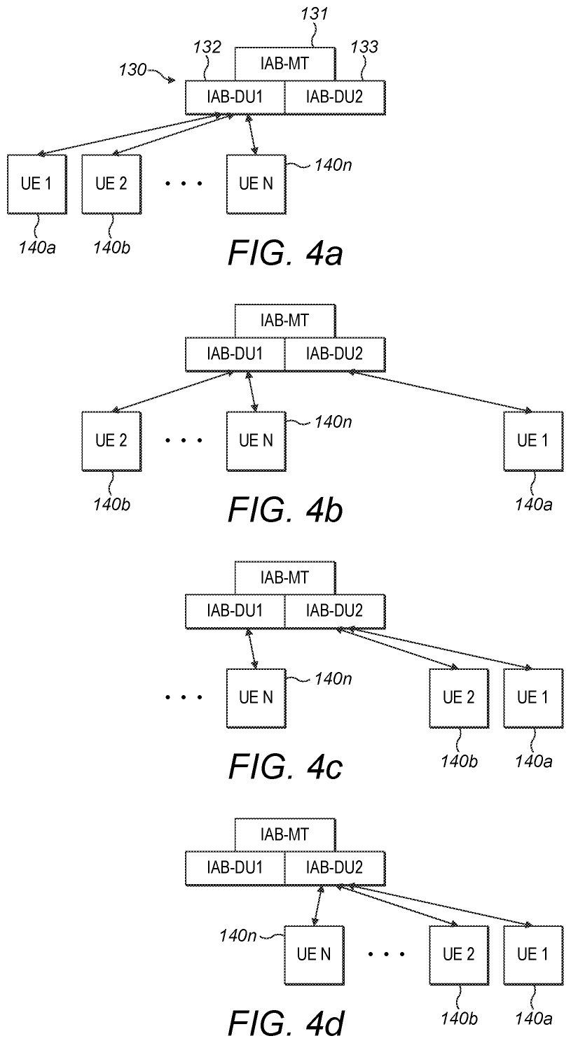

Controller/processor 225 of IAB-donor-DU1 110, controller/processor 280 of mobile IAB node 130 and/or controller/processor 290 of UE 140, and/or any other component(s) may perform or direct operations described herein, and/or other processes as described herein. Memories 222, 282 and 292 may store data and program codes for IAB-donor-DU1 110, mobile IAB node 130 and UE 140, respectively. In some aspects, memory 222, 282 and/or memory 292 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the IAB-donor-DU1 110, mobile IAB node 130 and/or the UE 140, may cause the one or more processors, the UE 140, mobile IAB node 130 and/or the IAB-donor-DU1 110 to perform or direct operations of, for example, those of FIGS. 5, 6, 7, and 8, and/or other processes as described herein. In some aspects, executing instructions may include running the instructions, converting the instructions, compiling the instructions, interpreting the instructions, and/or the like.

In some aspects, a UE (e.g., UE 140) may include means for receiving a communication from mobile IAB node 130 or other network entity (NE) and means for transmitting, to the IAB node 130 or other NE, feedback based at least in part on the communication received from the NE. In some aspects, such means may include one or more components of UE 140 described in connection with FIG. 2, such as controller/processor 290, transmit processor 294, modulator/demodulator 274, antenna 240, receive processor 278, and/or the like.

In some aspects, a UE (e.g., UE 140) may include means for transmitting data to mobile IAB node 130 or other NE and means for receiving, from the mobile IAB node 130 or NE, feedback based at least in part on the data transmitted to the NE. In some aspects, such means may include one or more components of UE 140 described in connection with FIG. 2, such as controller/processor 290, transmit processor 294, modulator/demodulator 274, antenna 240, receive processor 278, and/or the like.

While blocks in FIG. 2 are illustrated as distinct components, the functions described above with respect to the blocks may be implemented in a single hardware, software, or combination component or in various combinations of components. For example, the functions described with respect to the transmit processors 242, 258 and 294, the receive processors 220, 260 and 278, may be performed by or under the control of respective controller/processor 225, 280 or 290 or may be separated out into additional lower level processors.

As indicated above, FIG. 2 is provided as an example. Other examples may differ from what is described with regard to FIG. 2. For example, an IAB node may operate in full duplex or in time division duplex manner. The arrangement of FIG. 2 can achieve either. Alternatively, for full duplex operation, separate uplink and downlink antennas or antenna arrays can be provided in any (or all) of the three units set out.

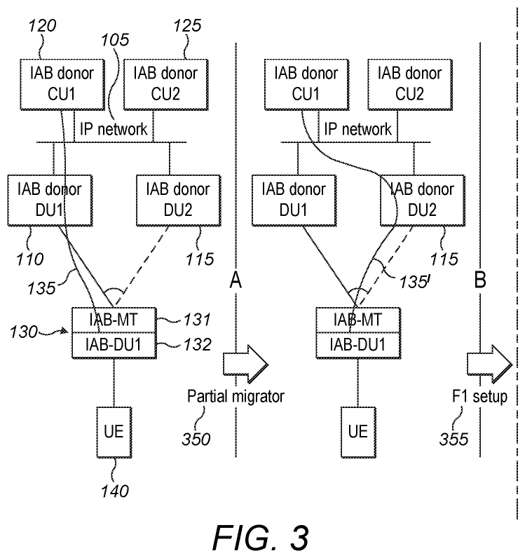

Referring now to FIG. 3, the various elements of FIG. 1 are illustrated, as have already been described. At 350, the IAB node 130 performs a partial migration from IAB-CU1 120 to IAB-CU2 125. The IAB-MT 131 connects to the IAB-donor-DU2 115 from the IAB-donor-DU1 110, re-directing the F1 interface to a target path 135′ via the IAB-donor-DU2 115.

At 355, the situation is considered where the IAB node 130 has a second IAB-DU 133, referred to as IAB-DU2. The redirected F1 interface 135′ still connects the IAB-node 130 to the IAB-donor-CU1 120 via the IAB-donor-DU2 115 and a second F1 interface connects IAB-DU2 133 to the candidate IAB-donor-CU2 125 via the IAB-donor-DU2 115. In this way, UE handover from the IAB-DU1 to the IAB-DU2 and from the CU1 to the CU2 can be prepared.

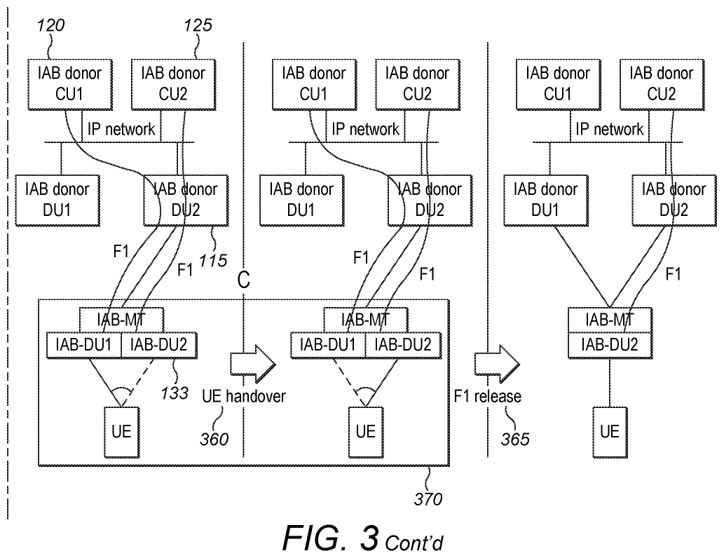

At 360, UE handover occurs by transferring the UE 140 from IAB-DU1 132 to IAB-DU2 133. This process within box 370 is discussed in greater detail below with reference to FIG. 4.

At 365, the connection across the F1 interface from the IAB-DU1 through to the CU1 is released, thereby completing the IAB inter-donor full migration. CU2 has assumed the responsibilities from CU1 for further candidate DUs to which the UE may need to handover.

Without full migration, UE traffic served by an IAB-node 130 has to route through a donor-DU 115 of the second donor to the donor-CU 125 of the first donor. Such triangular routing is disadvantageous as it incurs latency. Moreover, if the IAB-node 115 moves too far away (e.g., outside the general area of IAB-nodes and donor DU(s) that use the same CU 120 and collectively serve the function of a gNB covering the given area), it is preferable to do a full migration to align the IAB-donor-CU 125 and IAB-donor-DU 115 and cut down on latency.

The IAB node may be implemented in any number of physical arrangements. An IAB-MT and associated logical IAB-DUs may share or have dedicated antennas before or after the IAB-node's migration or the UE's migration.

The IAB-DUs 110 and 115 are logical. When an IAB-node 130 establishes a new F1 connection to a new donor-CU 125, this instantiates a new logical IAB-DU 133 on the IAB-node. Upon establishing an F1 connection, there may be an air interface broadcast corresponding to that F1 connection. This is when the IAB-node 130 reports cell information on an F1 connection to a IAB-donor-CU 125, and the IAB-donor-CU 125 responds with an activation instruction of that cell, in effect creating a new “cell”. When cell air interface is ON, it may share physical hardware of other cells of the same or other DUs or the IAB-MT 131. It may also use dedicated hardware.

In some aspects, one IAB-donor may have one IAB-donor-CU 120 and multiple IAB-donor-DUs 110.

Referring to FIGS. 4a-4d, details of the process in box 370 of FIG. 3 are shown. The mobile IAB node 130 is shown. The mobile IAB node comprises the mobile IAB-MT 131 and first and second DUs 132 and 133, respectively. IAB-DUs 132 and 133 may have different coverage (with or without overlap). The IAB node 130 serves a number of UEs 140a, 140b . . . 140n.

In FIG. 4a, the IAB-DU1 132 communicates with the UEs, and a backhaul connection is provided by the IAB-MT 131 for communicating via a suitable donor DU (e.g., IAB-donor-DU1 110 in FIG. 1) across an F1 link. The resultant connection enables the UEs 140 to communicate with the IAB-MT 131 which provides backhaul links to the IAB-donor-DU1 110 (FIG. 1). The second distributed unit IAB-DU2 133 is available for handover of one or more UEs.

FIG. 4b shows an example of an initiated handover procedure. For example, this may be due to a full inter-donor migration or physical cell ID reconfiguration, which would require the migration of the UEs connected to the IAB-DU1 132 to a new IAB-DU2 133 (a new IAB cell) or to an outside cell. One or more UEs, represented by UE 140a, establish a new link with IAB-DU2 133 and establish communication with the IP network 105 through IAB-DU2 133 and IAB-donor-DU2 115. Once established, the link with IAB-DU1 132 is terminated, completing the handover of the UE 140a.

FIG. 4c shows an example of the handover procedure underway. In the example shown, a number of UEs 140a, 140b have been handed-over from IAB-DU1 132 to IAB-DU2 133 in the same manner as described in FIG. 3.

FIG. 4d shows an example of the handover procedure at completion. In the example shown, all the UEs 140a to 140n have been handed-over from IAB-DU1 132 to IAB-DU2 133 in the same manner as described in FIG. 4b. Once all UEs have been disconnected from IAB-DU1 132 and connected to IAB-DU2 133, the handover procedure is deemed as complete. The IAB-DU1 132 no longer serves any UEs and can be switched off. At a minimum, its RF interface can be switched off, thereby conserving mobile power. It may remain in sleep mode, ready to be woken up by a signal from its controlling CU or autonomously under other conditions.

The handover procedure shown in FIGS. 4a-4d is for explanatory purposes only. No order is implied by UEs 140a, 140b, and 140n. The handover (HO) of UEs 140a, 140b, and 140n may occur in any combination or simultaneously.

A handover of an individual UE 140a or 140b through 140n may occur for a number of reasons, such as a change in environmental conditions between the IAB node 130 and the UE. A handover of all UEs 140a-140n served by the IAB-DU1 132 may be necessary for a number of reasons, such as a change in environmental conditions surrounding IAB-DU1 132 or because of a need to hand-over from a degraded backhaul link to a new backhaul link with superior channel qualities.

Methods for a full IAB inter-donor full migration may include configuring all UEs 140a-140n to be handed-over under the same conditions. For example, when an initial IAB-DU cell (IAB-DU1 132) connected to the UEs 140a-140n is switched off. The UEs detect the drop of link to the initial IAB-DU cell, and handover is triggered to a new IAB-DU cell (IAB-DU2 133). All the UEs subsequently attempt to perform handover together. This is not an efficient process, as the UEs may attempt random access to the new IAB-DU cell and the random access channel (RACH) may become congested. Access attempts between two UEs may collide and neither may receive service. They may both attempt access again and collide again.

The UEs 140a-140n also experience latency between the initial IAB-DU1 132 being switched off and the UEs realizing that the link has been lost. In addition, if the initial IAB-DU1 is not switched off, handover conditions may never be fulfilled, thus disabling migration.

Accordingly, it is proposed that a UE 140a performs conditional handover (CHO). The UE receives a configuration for CHO associated with a target IAB-DU2 133 and it receives an indication or command to execute the CHO. The UE initiates handover to the second IAB-DU2 133 subject to the condition being satisfied. By instructing the UEs to execute a stored CHO configuration, the aforementioned problems can be avoided.

In intra-NR radio access network (RAN) CHO, the preparation and execution phase of the CHO procedure is performed without involvement of a 5G Core (5GC). Preparation messages are directly exchanged between IAB-DUs 132, 133. The release of the resources at a source IAB-DU1 132 during HO completion phase is triggered by the target IAB-DU2 133.

FIG. 5 is a flow diagram illustrating an example intra-AMF/UPF conditional handover. The AMF (Access and Mobility Management Function) is an entity that typically receives connection and session related information from a UE and is responsible for handling connection and mobility management tasks. Messages related to session management are typically but not necessarily handled at a Session Management Function. The UPF (User Plane Function) is an interconnect point between mobile infrastructure and the wider data network. It may be a Protocol Data Unit (PDU) session anchor point for providing mobility within and between Radio Access Technologies (RATs), including sending one or more end marker packets to a gNB or IAB node. Per-flow QoS handling may occur here. The AMF and the UPF may or may not stay the same. The example is considered in which they do not change.

FIG. 5 shows a UE 501, a source NE 502, a target NE 503, other possible candidate NEs 504, such as a target IAB-DU, an AMF 505 and a UPF 506. There may be, for example, up to 8 target and candidate NEs. The NEs 502 and 503 may be DUs of an IAB such as IAB-DU1 132 and IAB-DU2 133 of FIG. 3, or they may be gNB nodes without integrated backhaul or they may be a mix of these. In the following description, they will be described generically.

Initially, user data is transmitted uplink and downlink between the UE 501 and the source NE 502, and between the source NE 502, and the UPF 506.

At 508, mobility control information is provided by the AMF to the source NE 502 and target NE 503. A UE context stored within the source NE 502 contains information regarding roaming and access restrictions which were provided either at connection establishment or at the last timing advance update.

At 510, the UE 501 receives one or more CHO configurations from the source NE, and the UE cold reports back according to the measurement configuration. The NE 502 is typically not the originator of these configurations. In the case of IAB, they may originate from a CU and the reports return to the CU via the source NE

At 515, the source NE decides to use conditional handover (CHO). This means that handover will be conditional based on a configuration for CHO given to the UE and based on some condition. In the present case the condition is a condition relating to the UE's measurement report and radio resource management (RRM) information. This configuration can alternatively be created at another entity such as a CU and conveyed to the source NE 502.

At 520, the source NE issues a handover request message to the target NE 503 (or the other potential candidate NEs). The source NE passes to the target NE 503 and other candidate NE(s) 504 a transparent radio resource control (RRC) container with information to prepare the handover at the target side. For example, each of the candidate NEs may be a potential target NE for the UE to handover to. A handover request message is sent for to each potential candidate NE 504.

The information may include some or all of: the candidate NE identification; a key derived by the UE and the source NE when performing horizontal or vertical key derivation; the cell radio network temporary identifier (C-RNTI) of the UE in the source NE; RRM-configuration including UE inactive time; basic AS-configuration including antenna information and DL Carrier Frequency; the current Quality of Service (QoS) flow to data radio bearer (DRB) mapping rules applied to the UE; the systems information block 1 (SIB1) from source NE; the UE capabilities for different RATs; and PDU session related information. The C-RNTI is a unique identification used for identifying an RRC connection between a network side unit and a user side unit, and is also used for UE-specific scheduling. The DRB may define packet treatment of user data on the radio interface and may be distinguished from signaling radio bearer. Examples of the QoS parameters include but are not limited to guaranteed (or non-guaranteed) bit rate, priority handling, packet delay budget and packet error loss rate. Different types of carriers may be classified into different classes, with each class having appropriate QoS parameters for the traffic type. SIB1 may carry UE evaluation information when a UE accesses a cell unit.

It can also include the UE reported measurement information including beam-related information if available. The source NE may also request a Dual Access Protocol Stack (DAPS) handover for one or more DRBs, in which a source gNB or IAB-DU connection is maintained (including UE data flow) until after successful random access to a target gNB or IAB-DU.

After issuing a handover request, the source NE should not reconfigure the UE, including performing reflective QoS flow to DRB mapping.

The source NE may also issue a handover request message to the other potential candidate NEs 504.

At 525, admission control may be performed by the target NE 503. Slice-aware admission control is performed if slice information is sent to the target NE 503. If PDU sessions are associated with non-supported slices the target NE 503 rejects PDU sessions. Admission control may also be performed by the other potential candidate NEs 504.

At 530, the target NE 503 sends a handover request acknowledge message to the source NE 502. Other candidate NEs 504 may also send such acknowledgements. (Any candidate that acknowledges may at this point be a “target”.)

At 535, the source NE 502 sends an RRCReconfiguration message to the UE 501, containing the CHO configuration(s) of target NE 503 and (optionally) other candidate NEs 504, including CHO execution condition(s). The CHO configuration(s) of target NE 503 can be followed by other reconfiguration from the source NE 502.

At 540, the UE 501 sends a RRCReconfigurationComplete message to the source NE 502. This confirms that the UE now has the new CHO configuration(s) with their execution condition(s).

At 541, the UE makes an empirical evaluation of link conditions and compares these against the configuration (or configurations) for CHO. If a condition for CHO contained in one of the configurations is satisfied, this triggers the start of handover to the new cell with which the configuration is associated.

An example of link condition is signal strength or quality, for example as measured by Reference Signal Received Power (RSRP) or Reference Signal Received Quality (RSRQ). Reference Signal Signal-to-Interference & Noise Ratio (RS-SINR) is an alternative measure.

An example of a condition that may trigger handover is where the target cell (e.g., target network entity) becomes offset better than the serving cell (e.g., source network entity). This is the case when:

Mn+Ofn+Ocn−Hys>Mp+Ofp+Ocp+Off
where:
Mn is the measurement result of the neighbouring (target or candidate) cell, not taking into account any offsets;
Ofn is the measurement object specific offset of the reference signal of the neighbour cell;
Ocn is the cell specific offset of the neighbour cell, and set to zero if not configured for the neighbour cell;
Hys is a hysteresis parameter for this event;
Mp is the measurement result of the serving cell, not taking into account any offsets;
Ofp is the measurement object specific offset of the serving cell;
Ocp is a cell specific offset of the serving cell, and is set to zero if not configured for the serving cell; and
Off is an offset parameter for the particular event, and where:
Mn, Mp are expressed in dBm in case of RSRP, or in dB in case of RSRQ and RS-SINR; and Ofn, Ocn, Ofp, Ocp, Hys and Off are expressed in dB.

The above inequality may be referred to as an “entering condition.” There can also be a leaving condition for the event, where:

Mn+Ofn+Ocn+Hys<Mp+Ofp+Ocp+Off

Another example of a condition may be where the neighboring cell exceeds a threshold. A further example is where the signal from the serving cell becomes worse than a first threshold and that of the neighbor becomes better than a second threshold.

There may be more than one condition for triggering handover to a particular cell. A CHO configuration for a given target cell is a specification of the conditions that pertain for that target cell.

At 545, if early data forwarding is applied, the source NE 502 sends an early status transfer message to the one or more candidate NEs.

The UE maintains connection with the source NE after receiving the CHO configuration, and starts evaluating the CHO execution conditions for the candidate NEs. If at least one CHO candidate NE satisfies a corresponding CHO execution condition (for that NE), the UE detaches from the source NE at step 542, applies the stored corresponding configuration for that selected candidate, or target, NE, synchronizes to that target NE and completes the RRC handover procedure at 550 by sending an RRCReconfigurationComplete message to the target NE.

At 550, the UE releases the stored CHO configuration after successful completion of RRC handover procedure. Further steps of FIG. 5 are explained merely for completeness of explanation.

At 555, the target NE 503 sends a handover success message to the source NE 502 to inform that the UE has successfully accessed the target NE.

At 560, in reply to the handover success message from the target NE, the source NE sends a say-nothing (SN) status transfer message to the target NE. Late data forwarding may also be initiated as soon as the source NE receives the handover success message.

At this point, data can be routed between the UPF 506 and the new serving NE, (via the previous serving NE as a temporary step).

At 565, the source NE sends a handover cancel message toward the other signaling connections or other candidate NEs 504, if any, to cancel other CHOs for the UE.

At 570, the target NE 503 (now the serving NE) sends a path switch request message to the AMF to trigger switching of the DL data path towards the target NE 503 and to establish a next generation core (NGC) interface instance towards the target NE 503.

At 575, the 5GC switches the DL path towards the target NE 503. The UPF sends one or more “end marker” packets on the old path to the source NE 502 per PDU session/tunnel and then can release any user-plain/transport network layer (TNL) resources towards the source NE 502.

At 580, the AMF 505 confirms the path switch request message with a path switch request acknowledge message.

At 585, upon reception of the path switch request acknowledge message from the AMF 505, the target NE 503 sends the UE context release to inform the source NE 502 about the success of the handover. The source NE 502 can then release radio and control-plane related resources associated to the UE context. Any ongoing data forwarding may continue and the process can begin again for the next target NE 504 (or 502).

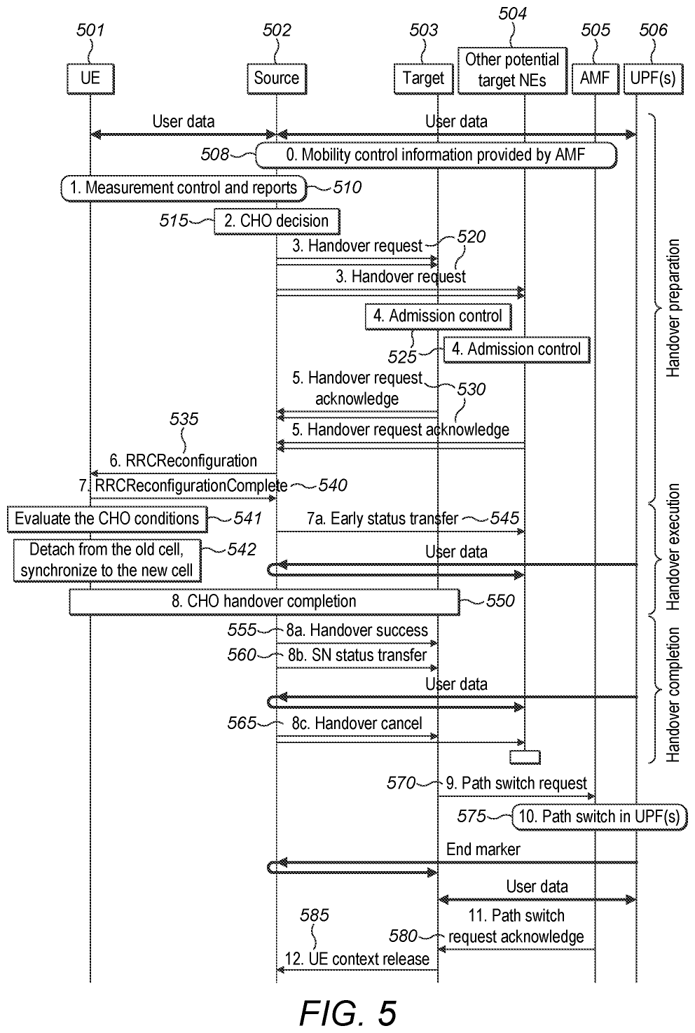

Turning now to FIG. 6, a variation of the above process will be described. The process of FIG. 6 will be described in the context where the source NE is an IAB-DU, but this is not essential and the description applies to any NE. The target NE will also be described in the context of another IAB-DU, but it may be understood that the target NE need not have IAB functionality. For illustrative purposes, the source and target NEs will be described as two DUs (e.g., IAB-DU1 132 and IAB-DU2 133 in FIGS. 3, 4a-d) of the same IAB node.

FIG. 6 is a flow diagram illustrating an example of a conditional handover in accordance with aspects of the present disclosure. The figure shows a UE 601, a source NE 602 (for example a first IAB-DU1 132 from FIGS. 3 and 4), a target NE 603 (for example a second IAB-DU2 133 from FIGS. 3 and 4), a first CU 604 (for example IAB-donor-CU1 120 of FIG. 3), a second CU 605 (for example IAB-donor-CU2 125 of FIG. 3) and a user plane function (UPF) 606.

Initially, user data is transmitted uplink and downlink between the UE 601 and the source NE 602, and between the source NE 602, and the UPF 606.

Procedures 510-540 of FIG. 5 have been described with respect to multiple candidate NEs and an AMF. FIG. 6 does not show an AMF. Procedures 510-530 in FIG. 6 are carried out in similar manner as FIG. 5 and will not be described again.

At 535, the source NE sends an RRCReconfiguration message to the UE, containing CHO configuration(s) of candidate NEs, including CHO execution condition(s). This configuration or these configurations can include configuration(s) as previously described with reference to FIG. 5. Alternatively or in addition, one or more new CHO conditions can be included, as will be described.

At 641, the UE 601 makes an empirical evaluation of link conditions and compares these against the configuration (or configurations) for CHO. If a condition for CHO contained in one of the configurations is satisfied, this triggers the start of handover to the target NE (e.g., NE 603) with which the configuration is associated. There may be more than one condition for triggering handover to a particular NE. A CHO configuration for a given candidate NE is a specification of the conditions that pertain for that candidate NE. If at least one CHO candidate NE satisfies a corresponding CHO execution condition (for that NE), the UE sends a message to the source NE 602 indicating that a conditional has been satisfied and CHO is to be carried out with the target NE 603.

The situation will be considered where, at 641, no CHO conditions have yet been satisfied.

At 642, the source NE 602 may send one or more instructions (e.g., an indication) to the UE 601 to execute a CHO.

The indication may be sent and received via one of: a MAC control element (MAC CE), a system information block (SIB); a downlink reference signal (DL RS); a wake-up signal (WUS), paging, or other suitable downlink signaling.

An indication may take the form “execute CHO no. 1 for target A”. In such case, CHO no. 1 may take the form “handover to target A on condition that indication is received.”

Alternatively, CHO no. 1 may take the form “handover to target A on condition that indication is received and Mn is above threshold T_{Mn}”. Note that these examples are the practically the same if T_{Mn} is set very low or set to zero.

Another example of a new CHO configuration is “handover to target A on condition that indication is received and Mp is below threshold T_{Mp}”. In this case, setting T_{Mp} very high has the same practical effect as simply “handover to target A on condition that indication is received.”

The source NE 602 may send an indication to execute a particular CHO configuration not evaluated at step 641, e.g., a configuration that is conditional upon receipt of an indication from the source NE 602 (or, alternatively, from a target NE 603). Such a configuration is one that the UE does not execute unless or until an indication is received from the source NE 602 (or from the target NE 603).

The indication may contain a single configuration or more than one different configurations. An example of the latter is “handover to target A on condition that indication is received and Mn is above threshold T_{Mn}, or handover to target A on condition that indication is received and Mp is below threshold T_{Mp}”. This is logically the same as “handover to target A on condition that indication is received and (Mn is above threshold T_{Mn} or Mp is below threshold T_{Mp})” and is the same as “on receipt of indication, handover to target A if (Mn is above threshold T_{Mn} or Mp is below threshold T_{Mp}). From these examples, it can be seen that many CHO configurations can be set up in advance, and an indication can be sent to execute a particular CHO configuration.

The indication may be UE-specific, indicating an arbitrary order in which multiple UEs are to execute their respective handovers, or indicating a sequential order in which multiple UEs are to execute their respective handovers.

The indication may contain different thresholds for the UE to evaluate in order for handover to be triggered.

The indication may be distributed to different subsets of the multiple UEs.

The indication could comprise a single or multiple delay-specific instructions, indicating a specific delay for each UE to wait for until executing handover.

The indication may contain different conditions which have already been configured by the UE to implement different delays when the conditions are evaluated.

There may a single indication, more than one indication, or a combination thereof of in the message sent from the source NE to the UE.

The source NE 602 may transmit a communication 650 to the CU1 604 to inform that a UE handover is about to occur with a new F1 interface from CU2. (Communication 650 may be sent before or after instructions 642.) The CU1 may then transmit a communication to the CU2 informing it of the handover. This signals to the CU2 that the new F1 interface is about to commence and thus also signaling the start of communications between CU2 and the UE.

At 643, the UE receives the instructions from the source NE and evaluates a second set of conditions. The second set of CHO conditions may be stored or pre-configured, received within the instructions, or a combination thereof.

The second set of conditions may be conditional simply on the receipt of an instruction from the source NE (and otherwise unconditional).

The second set of conditions may be conditional on link conditions, for example setting a lower threshold than any of conditions previously evaluated at 641. A threshold may be set sufficiently low to ensure that the UE completes the RRC handover procedure after instructions have been received.

If at least one CHO candidate satisfies a corresponding CHO execution condition from the second set of conditions (for that NE), the UE detaches from the source NE, applies the stored corresponding configuration for that selected candidate, or target, NE, synchronizes to that target NE and completes the RRC handover procedure at step 540 by sending an RRCReconfigurationComplete message to the target NE. The UE releases the stored CHO configuration after successful completion of RRC handover procedure.

The CHO may be a cell-specific configuration (and not a device specific configuration). For example, one DU may serve up to 512 cells, and CHO is executed to migrate a UE between these cells.

A “target NE” may refer to a second distributed unit of an IAB-node associated with a second CU, where the UE migrates via CHO from the first IAB-DU (e.g., IAB-DU1 132 of FIGS. 3, 4a-4d) to the second IAB-DU (e.g., IAB-DU2 133 of FIGS. 3, 4a-4d).

A target NE may be associated with a specific conditional handover configuration. Similarly, a specific conditional handover configuration may be associates with a particular target NE.

The signaling that carries the indication may be UE-specific, i.e., only one particular UE acts upon receiving the signaling. Alternatively, the signaling may address multiple UEs. Any of such UEs that receives the signaling will act upon the signaling. Thus, UEs may be migrated individually or in groups. An indication to execute a conditional handover may be specific to a UE or to a group of UEs of which the UE is a member.

The signaling may indicate a time at which the source cell (may also be referred to as a source NE or source IAB-DU) will be powered down (e.g., when its RF interface will power down).

Examples of group-common signaling could be group-common downlink control information (DCI) and group-common medium access control (MAC) control element (MAC-CE).

The described arrangements are particularly beneficial when the source and target cells for CHO belong to different DUs of the same IAB-node.

Advantageously, UEs connected to the source NE are able to each handover to the target NE in accordance with their respective received instructions. For example, when an initial IAB-DU cell connected to the UEs is switched off, the UEs detect the drop of link to the initial IAB-CU cell, and handover according to FIG. 6 is triggered to a new IAB-DU cell. The UEs subsequently perform handover according to their respective instructions when received from the source IAB-DU. The UEs hence avoid performing handovers simultaneously and thus the congestion of the RACH channel. Subsequent collisions from UEs re-attempting to perform handovers are also avoided, further increasing the efficient of the full migration. At the point of handover, the UE is connected to the source IAB-DU (e.g., IAB-DU1 132 of FIGS. 3, 4a-4d) and the target IAB-DU (e.g., IAB-DU2 133 of FIGS. 3, 4a-4d) is ready to receive the UE. The latency of the handover is thus decreased as there is no sudden realization from the UE that the initial IAB-DU link has been lost.

Procedures 550-585 of FIG. 6 have already been described in FIG. 5 and need not be explained further.

Each UE reports channel conditions it measures to the CU with which the UE is associated at any given time. The channel conditions are reported by the UE via the DU that is serving the UE. The DU also reports to the CU channel conditions it measures for the UE. In this way the CU “knows” all the channel conditions for UEs and DUs within its domain and is able to set appropriate CHO thresholds for handing UEs over from DU to DU. This allows the CU, for example, to balance traffic load on different DUs.

A CHO configuration for a particular UE is preferably generated at the CU associated with the DU currently serving the UE. Thus, for example, CU1 generates CHO configurations for UEs being served by DU1 (and other DUs within its domain) and, after full migration, CU2 will assume the task of generating CHO configurations for the UE and other UEs being served by DU2.

Where a CHO configuration is conditional upon receipt by the UE of an execution instruction, execution conditions for executing the CHO configuration at the UE are determined/evaluated at the source NE 602. If it is determined that the CHO configuration should be executed, the indication or instructions 642 are sent to the UE.

An example of the circumstances when the CHO configuration should be executed is an imminent switching off of the source NE 602. Another example is overload of the source NE 602, requiring it to shed some of the UEs it is serving. Another example is deteriorating channel conditions at the source NE 602, also requiring it to shed some of the UEs it is serving or to shed particular UEs that are suffering from such conditions.

A CHO configuration generated for a given UE may contain configuration for one or more candidate NE(s).

A NE (e.g., a DU) may send indications to different UEs or groups of UEs at different times. In this way, handover of the UEs from a source NE 602 to a target NE 603 may be staggered to avoid collisions.

A UE may store multiple CHO active configurations at a given time and continuously evaluate the conditions of each. An indication sent by a NE may indicate which of multiple configurations stored at a UE is to be executed.

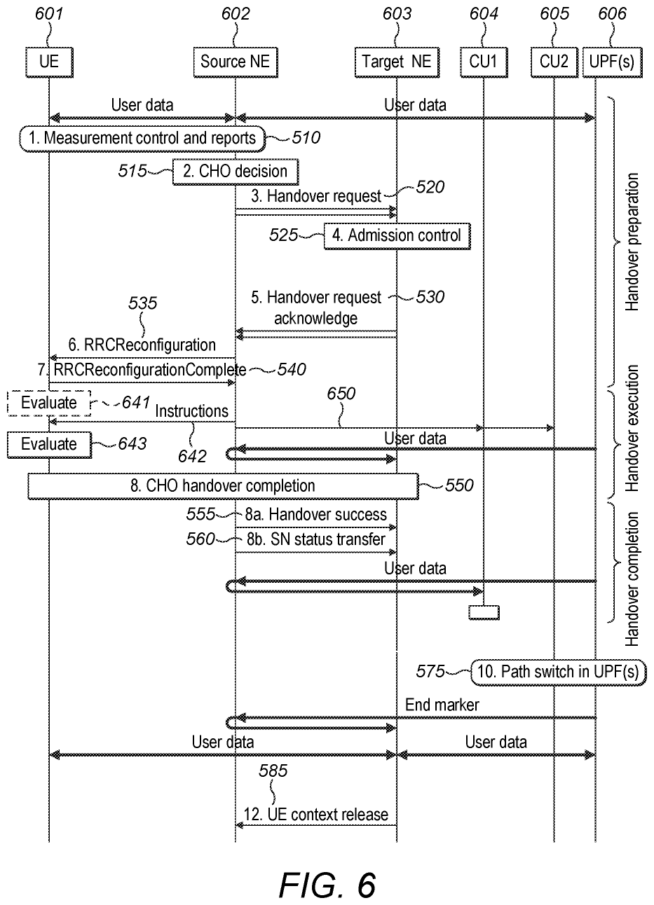

FIG. 7 shows a flowchart illustrating a method 700 that supports communications in accordance with one or more aspects of the present disclosure. The operations of the method 700 may be implemented by a UE or its components as described herein. For example, the operations of the method 700 may be performed by processor 290 of UE 140 as described with reference to FIGS. 1, 2, 3 and 4 or by a UE 601 as described with reference to FIG. 6. In some examples, a UE may execute a set of instructions to control the functional elements of the UE to perform the described functions. Additionally, or alternatively, the UE may perform aspects of the described functions using special-purpose hardware.

At 705, the UE may receive (e.g., 535 in FIG. 6, received at UE receive processor 278 of FIG. 2), from a first NE (e.g., 602), a configuration for conditional handover associated with a second NE (e.g., 603), the configuration including at least one condition.

At 710, the UE may receive (e.g., 642 in FIG. 6, also received at UE receive processor 278) an indication from the first NE to execute the conditional handover.

At 715, the UE may initiate handover (e.g., 542, FIG. 5 initiated by processor 290 of FIG. 2) from the first NE to the second NE subject to the condition being satisfied.

In an example, the at least one condition may be that the indication is received. The UE receive processor may report a number of conditions such as channel conditions to processor 290. A CHO that is conditional on the mere receiving of the indication will over-ride other conditions the UE may be monitoring for CHO.

In an example, the at least one condition may be a channel condition and the method may further comprise: monitoring the channel, determining when the channel condition is satisfied, and initiating handover from the first NE to the second NE when the indication is received and the channel condition is satisfied.

In an example, the configuration may include a first execution condition and a second execution condition. The UE may initiate handover to the second NE (e.g., at 643 in FIG. 6) based on fulfillment of the first execution condition on reception of the indication, or initiate handover to the second NE based on fulfillment of the second execution condition (e.g. at 641 in FIG. 6.) The latter may be independent of reception of the indication. Such an arrangement allows for CHO based on channel conditions and over-riding, when necessary, by sending the indication.

In an example, the indication may be specific to the UE or to a group of UEs of which the UE is a member. In this way, individual UEs or groups of US can be caused to perform HO independent of other UEs (e.g., at different times) and UEs can be migrated in groups.

In an example, the indication may indicate which of a plurality of configurations for conditional handover received by the UE is to be executed. (A UE may receive a number of CHO configurations and these may be active at the same time or different times.)

In an example, the indication may indicate a target NE associated with a configuration for conditional handover. Different configurations may be associated with different candidate NEs.

In an example, the indication may be an indication that a radio interface (supported, for example, by antennas 230a-230r) of the first NE (e.g., IAB node 130 of FIG. 2) is about to be powered down. The indication may indicate a time upon which the first NE will be powered down. This gives the UE forewarning and a window of time within which to handover. The UE may select a time (e.g., randomly) within that window to request HO and try to avoid collision with other UEs that may also be requesting HO.

In an example, the UE may report to the NE a capability to perform indication-triggerable conditional handover. Such capability signaling can be useful, as there may be legacy UEs that do not have the capability to accept indications for indication-triggerable CHO.

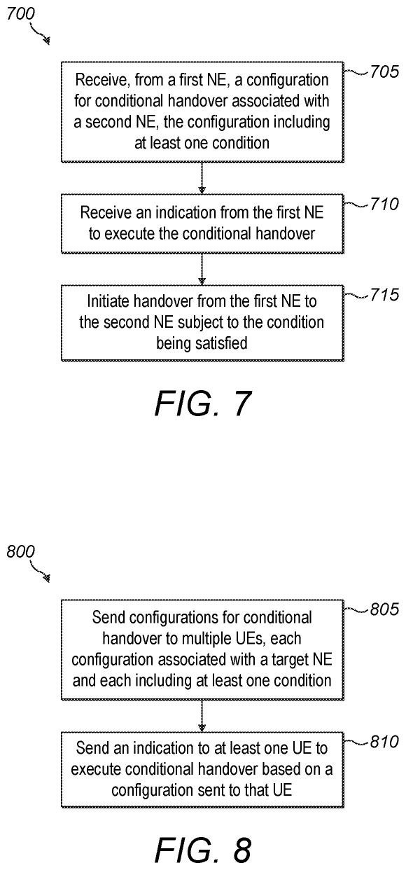

FIG. 8 shows a flowchart illustrating a method 800 that supports communications in accordance with one or more aspects of the present disclosure. The operations of the method 800 may be implemented by a NE or its components as described herein. For example, the operations of the method 800 may be performed by an IAB-DU 132 as described with reference to FIGS. 1, 2 (at IAB node 130), 3 and 4 or a source NE 602 as described with reference to FIG. 6. In some examples, a NE may execute a set of instructions to control the functional elements of the NE to perform the described functions. Additionally, or alternatively, the NE may perform aspects of the described functions using special-purpose hardware.

At 805, the NE may send configurations for conditional handover to multiple UEs, each configuration associated with a target NE and each including at least one condition. An example is the control processor 280 of IAB node 130 of FIG. 2 sending, via antennas 230a-230r, one or more configurations to UE 140.

At 810, the NE may send an indication to at least one UE to execute conditional handover based on a configuration sent to that UE.

In an example, the NE may send indications to the multiple UEs to execute respective conditional handovers when the NE determines that a radio interface (provided, for example, across antennas 230a-230r) of the NE is about to be powered down.

In an example, at least one configuration for conditional handover may be generated, at least in part, by the target NE (e.g., 603, FIG. 6) with which the configuration is associated.

In an example, the NE may be an IAB-DU having a CU coupled thereto, and the at least one configuration for the at least one UE may be received, at least in part, by the CU from the target NE and forwarded to the at least one UE via the IAB-DU. The CU may have information relating to candidate target NEs of the at least one UE. A CHO configuration for a UE of the multiple UEs may be generated at the CU. The CU may cause the DU to send indications to different UEs or groups of UEs at different times. This allows the DU (independently or under instruction from the CU) to stagger the sending of indications and thereby stagger requests for HO from the UEs, individually or in staggered groups.

In an example, each indication sent by the NE may be specific to a UE or a group of UEs.

In an example, the indication sent by the NE may indicate which of multiple configurations stored at a UE is to be executed.

In an example, the indication may indicate the target NE.

In an example, the indication may indicate that a RF interface of the NE will power down. After the sending of the indication, the NE may power down its RF interface. This may be a complete powering down of antennas 230a-230r, or may be powering down of a logical IAB-DU1 132 supported by those antennas while another logical IAB-DU2 133 continues, supported by the same or different antennas.

In an example, the NE and the target NE may be first and second IAB-DUs having first and second CUs, e.g., IAB-donor-CU1 120 and IAB-donor-CU2 125. The at least one UE may migrate from the first IAB-DU in association with the first CU to the second IAB-DU in association with the second CU.

In an example, the NE may receive a UE capability report from a UE indicating that the UE supports triggering by the indication of conditional handover. The NE may send the indication based on the UE capability report (e.g., send an indication if the UE has indicated a capability to perform indication-triggered CHO, and not send any indication if the UE has not indicated a capability to perform indication-triggered CHO, for example because it is a legacy UE).

The above description is given by way of example only. Modifications of detail can be made within the scope of the appended claims.

It should be noted that the methods described herein describe possible implementations, and that the operations and the steps may be rearranged or otherwise modified and that other implementations are possible. Further, aspects from two or more of the methods may be combined.

Although aspects of an NR system may be described for purposes of example, and NR terminology may be used in much of the description, the techniques described herein are applicable beyond NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

The following aspects are illustrative only and may be combined with other aspects or teachings described herein, without limitation.

Aspect 1 is a method of handover at a user equipment (UE) including: receiving, from a first network entity (NE) a configuration for conditional handover associated with a second NE, the configuration including at least one condition, receiving an indication from the first NE to execute the conditional handover, and initiating handover from the first NE to the second NE subject to the at least one condition being satisfied.

Aspect 2 is a method of aspect 1, where the at least one condition is that the indication is received.

Aspect 3 is a method of any of aspects 1 and 2, where the at least one condition is a channel condition and the method further includes: monitoring a channel, determining when the channel condition is satisfied, and initiating handover from the first NE to the second NE when the indication is received and the channel condition is satisfied.

Aspect 4 is a method of any of aspects 1 to 3, where the configuration includes a first execution condition and a second execution condition, and wherein the UE initiates handover to the second NE based on fulfillment of the first execution condition on reception of the indication, or initiates handover to the second NE based on fulfillment of the second execution condition.

Aspect 5 is a method of any of aspects 1 to 4, where the indication is specific to the UE or to a group of UEs of which the UE is a member.

Aspect 6 is a method of any of aspects 1 to 5, where the indication indicates which of a plurality of configurations for conditional handover received by the UE is to be executed.

Aspect 7 is a method of any of aspects 1 to 6, where the indication indicates a target NE associated with a configuration for conditional handover.

Aspect 8 is a method of any of aspects 1 to 7, where the indication is an indication that a radio interface of the first NE is about to be powered down.

Aspect 9 is a method of any of aspects 1 to 8, where the indication indicates a time upon which the first NE will be powered down.

Aspect 10 is a method of any of aspects 1 to 9, where the indication is carried using downlink control information (DCI), medium access control-control element (MAC-CE), or information specific to the UE or to a group of UEs of which the UE is a member.

Aspect 11 is a method of any of aspects 1 to 9, where the indication is received via one of: a system information block (SIB), downlink reference signal (DL-RS), a wake-up signal (WUS), or paging.

Aspect 12 is a method of any of aspects 1 to 11, further including reporting to the first NE a capability to support indication-triggerable conditional handover.

Aspect 13 is a method of handover at a first network element (NE) including: sending configurations for conditional handover (CHO) to multiple user equipments (UEs), each configuration associated with a target NE and each including at least one condition and sending an indication to at least one UE to execute conditional handover based on a configuration sent to the at least one UE.

Aspect 14 is a method aspect 13, where the first NE sends indications to the multiple UEs to execute respective conditional handovers when the first NE determines that a radio interface of the first NE is about to be powered down.

Aspect 15 is a method of any of aspects 13 and 14, where at least one configuration for conditional handover for at least one UE is generated, at least in part, by the target NE with which the configuration is associated.

Aspect 16 is a method of any of aspects 13 to 15, where the first NE is a distributed unit (DU) of an integrated access and backhaul system (IAB-DU) having a central unit (CU) coupled thereto; and the at least one configuration is received, at least in part, by the CU from the target NE and forwarded to the at least one UE via the IAB-DU.

Aspect 17 is a method of aspect 16, where the CU has information relating to candidate target NEs of the at least one UE.

Aspect 18 is a method of any of aspects 16 and 17, where a CHO configuration for a UE of the multiple UEs is generated at the CU.

Aspect 19 is a method of any of aspects 16 to 18, where the CU causes the IAB-DU to send indications to different UEs or groups of UEs at different times.

Aspect 20 is a method of any of aspects 13 to 19, where each indication sent by the first NE is specific to a UE or a group of UEs.

Aspect 21 is a method of any of aspects 13 to 20, where the indication sent by the first NE indicates which of multiple configurations stored at a UE is to be executed.

Aspect 22 is a method of any of aspects 13 to 21, where the indication indicates the target NE.

Aspect 23 is a method of any of aspects 13 to 22, where the indication is that a radio frequency (RF) interface of the first NE will power down and wherein, after the sending of the indication, the first NE powers down its RF interface.

Aspect 24 is a method of any of aspects 13 to 23, where the first NE and the target NE are first and second distributed units of an IAB node (IAB-DUs) having first and second central units (CUs), and where the at least one UE migrates from the first IAB-DU in association with the first CU to the second IAB-DU in association with the second CU.

Aspect 25 is a method of any of aspects 13 to 24, further including receiving a UE capability report to support triggering by the indication of conditional handover.

Aspect 26 is a method of aspect 25, where the first NE sends the indication based on the UE capability report.

Aspect 27 is an apparatus for wireless communication at a user equipment (UE). The apparatus includes memory; and at least one processor coupled to the memory and, based at least in part on information stored in the memory, the at least one processor is configured to implement any of aspects 1 to 12.

Aspect 28 is an apparatus for wireless communication at a network node. The apparatus includes memory; and at least one processor coupled to the memory and, based at least in part on information stored in the memory, the at least one processor is configured to implement any of aspects 13 to 26.

Aspect 29 is an apparatus for wireless communication including means for implementing any of aspects 1 to 12.

Aspect 30 is an apparatus for wireless communication including means for implementing any of aspects 13 to 26.

Aspect 31 is a computer-readable medium (e.g., a non-transitory computer-readable medium) storing computer executable code, the code when executed by at least one processor causes the at least one processor to implement any of aspects 1 to 12.

Aspect 32 is a computer-readable medium (e.g., a non-transitory computer-readable medium) storing computer executable code, the code when executed by at least one processor causes the at least one processor to implement any of aspects 13 to 26.

1. A method of handover at a user equipment (UE) comprising:
receiving, from a first network entity (NE) a configuration for conditional handover associated with a second NE, the configuration including at least one condition;
receiving an indication from the first NE to execute the conditional handover; and
initiating handover from the first NE to the second NE subject to the at least one condition being satisfied.

2. The method of claim 1, wherein the at least one condition is that the indication is received.

3. The method of claim 1, wherein the at least one condition is a channel condition and the method further comprises:
monitoring a channel,
determining when the channel condition is satisfied, and
initiating handover from the first NE to the second NE when the indication is received and the channel condition is satisfied.

4. The method of claim 1, wherein the configuration includes a first execution condition and a second execution condition, and wherein the UE initiates handover to the second NE based on fulfillment of the first execution condition on reception of the indication, or initiates handover to the second NE based on fulfillment of the second execution condition.

5. Apparatus for wireless communication at a user equipment (UE), comprising:
a memory; and
one or more processors coupled to the memory, and wherein the one or more processors are configured to:
receive, from a first network entity (NE) a configuration for conditional handover associated with a second NE, the configuration including at least one condition;
receive an indication from the first NE to execute the conditional handover; and
initiate handover from the first NE to the second NE subject to the at least one condition being satisfied.

6. The apparatus of claim 5, wherein the one or more processors are configured to receive the configuration for conditional handover, the configuration including a first execution condition and a second execution condition, and are configured to monitor a channel and to initiate handover to the second NE based on fulfillment of the first execution condition on reception of the indication, or based on determining when a channel condition is satisfied.

7. The apparatus of claim 5, wherein the configuration includes a first execution condition and a second execution condition, and wherein the one or more processors are configured to initiate handover to the second NE based on fulfillment of the first execution condition on reception of the indication, or initiate handover to the second NE based on fulfillment of the second execution condition.

8. The apparatus of claim 5, wherein the indication is specific to the UE or to a group of UEs of which the UE is a member.

9. The apparatus of claim 5, wherein the indication indicates which of a plurality of configurations for conditional handover received by the UE is to be executed.

10. The apparatus of claim 5, wherein the indication indicates a target NE associated with a configuration for conditional handover.

11. The apparatus of claim 5, wherein the indication is an indication that a radio interface of the first NE is about to be powered down.

12. The apparatus of claim 5, wherein the indication indicates a time upon which the first NE will be powered down.

13. The apparatus of claim 5, wherein the one or more processors are configured to receive the indication as downlink control information (DCI), medium access control-control element (MAC-CE), or information specific to the UE or to a group of UEs of which the UE is a member.

14. The apparatus of claim 5, wherein the one or more processors are configured to receive the indication via one of:
a system information block (SIB),
downlink reference signal (DL-RS),
a wake-up signal (WUS), or
paging.

15. The apparatus of claim 5, wherein the one or more processors are configured to report to the first NE a capability of the UE to support indication-triggerable conditional handover.

16. A method of handover at a first network entity (NE) comprising:
sending configurations for conditional handover to multiple user equipments (UEs), each configuration associated with a target NE and each including at least one condition; and
sending an indication to at least one UE to execute conditional handover based on a configuration sent to the at least one UE.

17. The method of claim 16, wherein at least one configuration for conditional handover for at least one UE is generated, at least in part, by the target NE with which the configuration is associated.

18. The method of claim 17, wherein:
the first NE is a distributed unit (DU) of an integrated access and backhaul node (IAB-DU) having a central unit (CU) coupled thereto; and
the at least one configuration is received, at least in part, by the CU from the target NE and forwarded to the at least one UE via the IAB-DU.

19. The method of claim 18, wherein the CU has information relating to candidate target NEs of the at least one UE.

20. The method of claim 18, wherein a conditional handover configuration for a UE of the multiple UEs is generated at the CU.

21. The method of claim 20, wherein the CU causes the IAB-DU to send indications to different UEs or groups of UEs at different times.

22. Apparatus for wireless communication at a first network entity (NE), comprising:
a memory; and
one or more processors coupled to the memory, wherein the one or more processors are configured to:
send configurations for conditional handover to multiple user equipments (UEs), each configuration associated with a target NE and each including at least one condition; and
send an indication to at least one UE to execute conditional handover based on a configuration sent to that UE.

23. The apparatus of claim 22, wherein the one or more processors are configured to send indications to the multiple UEs to execute respective conditional handovers when the first NE determines that a radio interface of the first NE is about to be powered down.

24. The apparatus of claim 22, wherein each indication sent by the first NE is specific to a UE or a group of UEs.

25. The apparatus of claim 22, wherein the indication sent by the first NE indicates which of multiple configurations stored at a UE is to be executed.

26. The apparatus of claim 22, wherein the indication indicates the target NE.

27. The apparatus of claim 22, wherein the indication is that a radio frequency (RF) interface of the first NE will power down and wherein the one or more processors are configured to power down the RF interface after sending the indication.

28. The apparatus of claim 22, wherein:
the first NE and the target NE are first and second distributed units (DUs) of an integrated access and backhaul node (IAB-DUs) having first and second central units (CUs), wherein:
the at least one UE migrates from the first IAB-DU in association with the first CU to the second IAB-DU in association with the second CU.

29. The apparatus of claim 22, wherein the one or more processors are configured to receive a UE capability report to support triggering by the indication of conditional handover.

30. The apparatus of claim 29, wherein the one or more processors are configured to send the indication based on the UE capability report.
